(19) United States
(12) Patent Application Publication
(10) Pub. No.: US 2014/0253065 A1
(43) Pub. Date: Sep. 11, 2014

(54) REDUCING HIGH-FREQUENCY NOISE IN PULSE-SKIPPING MODE OF A VOLTAGE REGULATOR

(71) Applicants: James E. C. Brown, San Jose, CA (US); Pablo Moreno Galbis, Burlingame, CA (US); John O'Boyle, III, San Francisco, CA (US)

(72) Inventors: James E. C. Brown, San Jose, CA (US); Pablo Moreno Galbis, Burlingame, CA (US); John O'Boyle, III, San Francisco, CA (US)

(73) Assignee: R2 SEMICONDUCTOR, INC., Sunnyvale, CA (US)

(21) Appl. No.: 13/947,077

(22) Filed: Jul. 21, 2013

Related U.S. Application Data
(60) Provisional application No. 61/773,884, filed on Mar. 7, 2013.

(51) Int. Cl. H02M 3/158

(52) U.S. Cl. CPC H02M 3/158
USPC 323/272; 323/311

(57) ABSTRACT

Embodiments of systems, methods and apparatuses of a voltage regulator are disclosed. One apparatus of the voltage regulator includes a series switch element, wherein the series switch element comprises a plurality of partitioned series switch elements, a shunt switch element, and a switching controller. The switching controller is operative to control the series switch element and the shunt switch element in an idle state, wherein none of the plurality of partitioned series switch elements are active, control the series switch element and the shunt switch element in a burst state, wherein N of the plurality of partitioned series switch elements are active, and control the series switch element and the shunt switch element in a transition state, wherein M of the plurality of partitioned series switch elements are active, and wherein M is less than N.

### RELATED APPLICATIONS

This patent application claims priority to U.S. Provisional Patent Application 61/773,884, filed Mar. 7, 2013, which is herein incorporated by reference.

### FIELD OF THE DESCRIBED EMBODIMENTS

The described embodiments relate generally to power conversion. More particularly, the described embodiments relate to systems, methods and apparatuses to reduce high-frequency noise during operation in pulse-skipping mode.

### BACKGROUND

A switched DC-DC converter may be constructed from a set of switches and energy storage elements (inductors and capacitors). A simplified example of a buck converter 101 is given in FIG. 1. The series switch SW1 is shown in FIG. 1 as employing a PMOS transistor, but an NMOS transistor can also be used, with appropriate signal levels. FIG. 2 shows examples of switch control waveforms 210, 220 for the switches of the switched-mode DC-DC converter of FIG. 1. In pulse-width-modulated (PWM) operation, during each switching cycle, the series switch SW1 is turned on for a period T_{SW1}=DT_{sw}, where D is the duty cycle and T_{sw} is the switching period (FIG. 2). The series switch is then turned off and the shunt switch is turned on for a time T_{SW2}=(1-D)T_{sw}−T_{dead}, where T_{dead} is the dead time during which both switches are held off (Dead times are interposed to ensure that the two switches are not on simultaneously, which would permit current to flow directly from the supply to ground, with consequent excessive power dissipation and possible reliability impairment.) The output voltage of an ideal converter is DV_{IN}, where V_{IN} is the input supply voltage. In a real converter, the output voltage is reduced from the ideal value due to the presence of finite parasitic resistance, inductance, and capacitance.

In PWM operation with a constant clock frequency, the state of the switches is changed every clock. The change in switch state is typically accomplished by charging and discharging the capacitance of a transistor gate; in non-resonant implementations, the charge removed from the gate is then sent to ground and lost. Thus, there is a driver power consumption of at least C_{gate}V_{gate}²f_{SW} to operate each switch in PWM mode, where C_{gate} is the gate capacitance of the switch, V_{gate} the change in voltage needed to change the switch from the OFF state to the ON state, and f_{SW} is the switching frequency. Typically the requirement for a driver circuit to provide the control signals to the switching transistors increases overall power consumption by a factor of 1.5 to 2. In addition, switching losses within the transistor occur at each switching transition where both the current and the voltage across the transistor during switching are non-zero. Thus, substantial power is required to operate in PWM mode. When the load power is small, the efficiency of the DC-DC conversion process may be very poor, particularly if a high switching frequency is employed to ensure rapid control response at high load conditions.

To improve light-load efficiency, it is well-known to provide a lower-power mode in which the switches spend much of the time in a fixed state (typically both off). Reduced power operation is variously known as pulse-frequency mode, pulse-skipping mode, discontinuous mode, and so on, depending on the exact approach used to control the converter in this mode. For example, a pulse-skipping mode (PSM) may be employed in which the converter produces bursts of switching pulses at a fixed frequency, followed by periods in which no switching takes place. An idealized example of this type of operation is depicted in FIG. 3. The trace 310 shows the switching node voltage V_{SW}. During the time t_{burst}, SW1 and SW2 are active as described above, and the switching node alternates between a voltage near the input voltage (when SW1 is on) and a voltage near ground (when SW2 is on). When the output voltage rises high enough, the burst is terminated by turning both switches off. The switch node settles to the output voltage (after some ringing, not shown in the diagram). Note that the VSW trace 310 uses a much larger vertical scale than the V_{OUT} trace 320, since ∂Vₕ is typically much less than V_{OUT}. During the time t_{idle} both switches are off, and the switching voltage is equal to the output voltage. The output voltage falls during this time, as shown by trace 320, but the changes are small and not readily visible at the larger scale used for trace 310. In most applications the time t_{idle}>>t_{burst} to achieve optimal power savings.

During the burst time, as shown by trace 320, the output voltage will rise as desired if the duty cycle is chosen to be higher than that required to provide the output voltage at the start of the burst. For example, during PSM operation, the duty cycle controller may receive feedback from an emulated “replica” converter, consisting of small switches and an output filter, instead of from the actual output. By imposing a target output voltage slightly higher than the actual voltage, e.g. D_{target}=D_{f}Vₒᵤₜ/Vᵢₙ where the duty factor D_{f}>1, the duty cycle rises to a higher value than required to maintain the nominal output voltage Vₒᵤₜ. The width of the voltage variation, δVₕ, is selected to meet the requirements of a given application. Various alternative means, such as insertion of a series offset voltage onto the reference voltage V_{ref}, or the sensed voltage Vₛₑₙₛₑ, may also be used.

In a real converter (such as, converter 401), the output capacitor has an associated equivalent series resistance ESR and equivalent series inductance ESL, depicted schematically in FIG. 4. The output voltage during a burst contains a contribution from the voltage across the resistance ESR due to the charging current of capacitance Cₒᵤₜ. The output voltage also contains a contribution due to the time rate of change of this current across the inductance ESL. Since the inductance ESL is generally much smaller than the output inductance, the two inductors Lₒᵤₜ and ESL can be regarded as a voltage divider, so that a fraction (ESL/Lₒᵤₜ) of VSW appears across the load. As a result, the output voltage is not a simple triangular ramp as shown in FIG. 3, but contains higher-frequency contributions.

The presence of finite ESL and ESR result in undesired high-frequency components in the output voltage. The output voltage variation due to ESL is substantially at the switching frequency and higher harmonics. By judicious selection of switching frequency, as described for example in U.S. Pat. No. 8,145,149, any resulting spurious output of a power amplifier driven by the converter may be minimized in the specific channels and bands of interest. However, the effect of an ESR-related sudden change in output voltage is to produce a broad output spectrum, which may contain power at inconvenient frequency ranges. When the converter is used to drive a radio-frequency power amplifier, the presence of high-frequency harmonics in the supply voltage from the converter may cause increased error-vector magnitude (EVM) when inside the transmitted channel, and increased adjacent-channel power ratio (ACPR) when outside the transmitted channel.

Methods of shaping PSM pulses in lower-switching-frequency converters to reduce the analogous audible harmonic content have been reported. Some methods employ linearly-increasing peak current with each switching pulse during a burst. These methods are intended for audible noise coupling due to magnetostriction, and are not helpful in reducing ESR-related harmonics from the termination of the pulse. For high-frequency converters, with switching frequency of 10 MHz and above, it is difficult to sense peak current rapidly enough to employ current-mode control, and thus voltage-mode control is preferred.

Some methods include the placement of one or more shortened (reduced-duty-cycle) pulses at the beginning and end of a PSM burst, used to minimize current peaks as well as reduce audible noise. These methods are applicable to harmonic reduction, but adjustment of individual pulse durations may be challenging to implement in a high-frequency converter. Therefore it is useful to employ an alternative method of reducing harmonic content due to output ESR.

### SUMMARY

An embodiment includes a voltage regulator. The voltage regulator includes a series switch element connected between a first voltage supply and a common node, wherein the series switch element comprises a plurality of partitioned series switch elements, a shunt switch element connected between a second voltage supply and the common node, and a switching controller that controls closing and opening of the series switch element and the shunt switch element, generating a switching voltage at the common node. The switching controller is operative to control the series switch element and the shunt switch element in an idle state, wherein none of the plurality of partitioned series switch elements are active, control the series switch element and the shunt switch element in a burst state, wherein N of the plurality of partitioned series switch elements are active, and control the series switch element and the shunt switch element in a transition state, wherein M of the plurality of partitioned series switch elements are active, and wherein M is less than N.

Another embodiment includes a voltage regulator. The voltage regulator includes a series switch element connected between a first voltage supply and a common node, wherein the series switch element comprises a plurality of partitioned series switch elements, a shunt switch element connected between a second voltage supply and the common node, a switching controller that controls closing and opening of the series switch element and the shunt switch element, generating a switching voltage at the common node. The switching controller is operative to control the series switch element and the shunt switch element in an idle state, wherein none of the plurality of partitioned series switch elements are active, and wherein a series resistance of series switch element is a value R_{off}, control the series switch element and the shunt switch element in a burst state, wherein a series resistance of the series switch element is a value Rₒₙ, and control the series switch element and the shunt switch element in a transition state, wherein a series resistance of the series switch element is a value Rₒₙ₁, wherein Rₒₙ₁ is greater than Rₒₙ, and Rₒₙ₁ is less than R_{off}.

Another embodiment includes a voltage regulator. The voltage regulator includes a series switch element connected between a first voltage supply and a common node, a shunt switch element connected between a second voltage supply and the common node, wherein the shunt switch element comprises a plurality of partitioned shunt switch elements, and a switching controller that controls closing and opening of the series switch element and the shunt switch element, generating a switching voltage at the common node. The switching controller is operative to control the series switch element and the shunt switch element in an idle state, wherein none of the plurality of partitioned shunt switch elements are active, control the series switch element and the shunt switch element in a burst state, wherein L of the plurality of partitioned shunt switch elements are active, and control the series switch element and the shunt switch element in a transition state, wherein K of the plurality of partitioned shunt switch elements are active, and wherein K is less than L.

Another embodiment includes a method of generating a regulated voltage. The method includes generating the regulated voltage through controlled closing and opening of a series switch element and a shunt switch element, the series switch element being connected between a first voltage supply and a common node, and the shunt switch being connected between the common node and a second supply voltage, wherein the series switch element comprises a plurality of partitioned series switch elements. The controlled closing and opening of a series switch element and a shunt switch element includes an idle state, wherein none of the plurality of partitioned series switch elements are active, a burst state, wherein N of the plurality of partitioned series switch elements are active, and a transition state, wherein M of the plurality of partitioned series switch elements are active, and wherein M is less than N.

### BRIEF DESCRIPTION OF THE DRAWINGS

FIG. 1 shows an example of an embodiment of a switched-mode DC-DC converter.

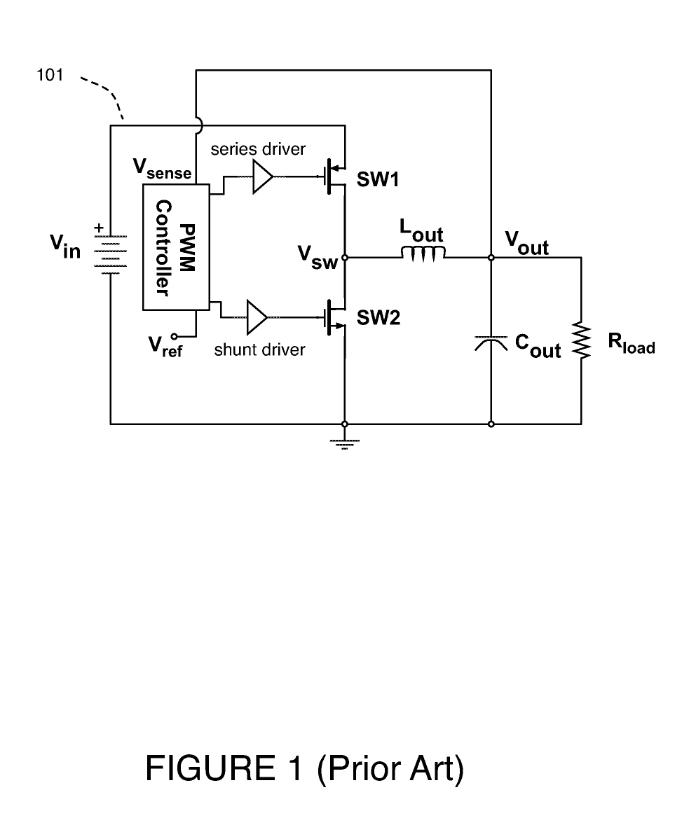

FIG. 2 shows examples of switch control waveforms for the switches of the switched-mode DC-DC converter of FIG. 1.

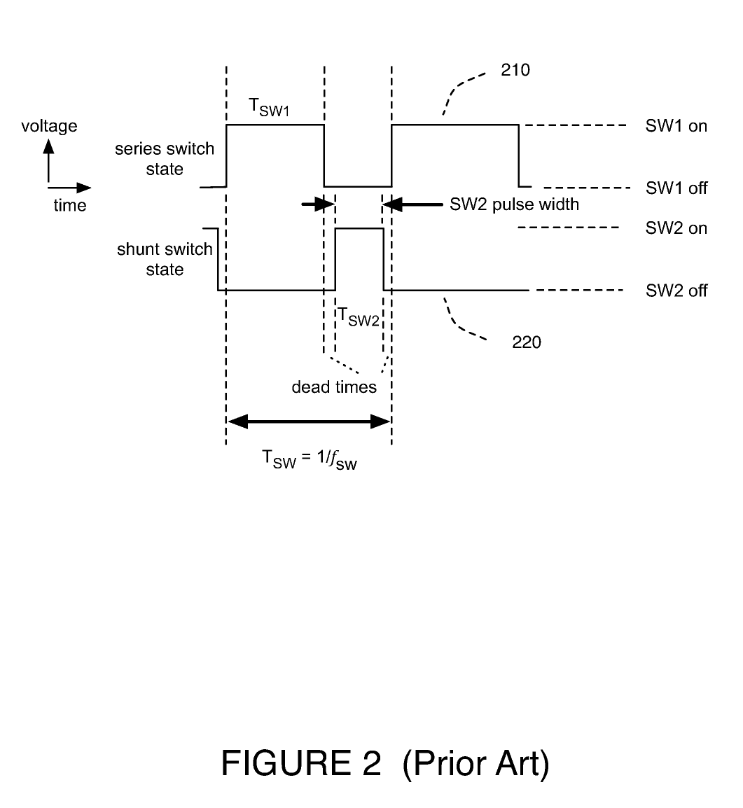

FIG. 3 shows in simplified form the time-dependent variation of the switch node voltage during PSM operation, and FIG. 3 also shows the resulting averaged output voltage.

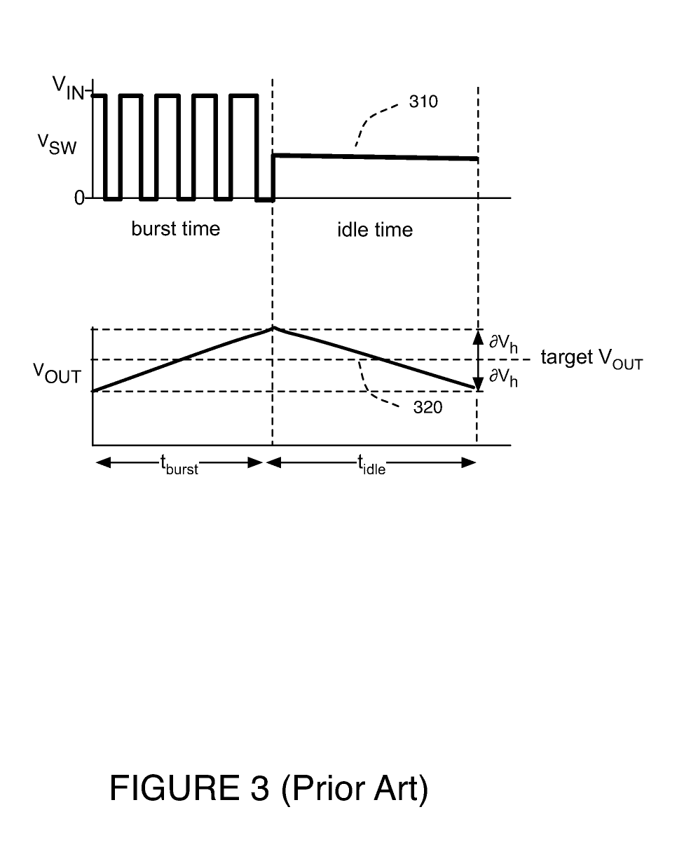

FIG. 4 shows an example switched-mode DC-DC converter including equivalent series resistance ESR and inductance ESL associated with the output capacitor.

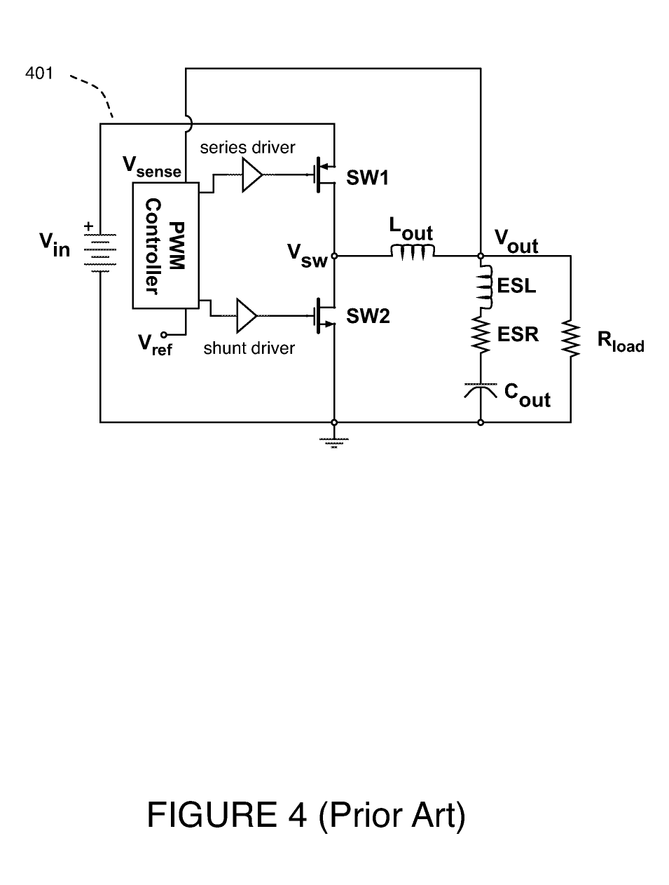

FIG. 5 shows the measured output voltage during a pulse-skipping-mode burst for a buck converter with 48 MHz switching frequency.

FIG. 6 shows a simplified analytic estimate of the output noise spectrum resulting from PSM operation with the charging waveform depicted in FIG. 5, compared to an ideal PSM converter with no ESL or ESR effects.

FIG. 7 shows a buck converter that includes a series switch element and a shunt switch element, wherein the series switch element includes a plurality of partitioned series switch elements, according to an embodiment.

FIG. 8 shows in simplified form the time-dependent variation of the switch node voltage during PSM operation for the burst mode, the transition mode and the idle mode, according to an embodiment, and FIG. 8 shows the resulting averaged output voltage for the burst mode, the transition mode and the idle mode, according to an embodiment.

FIG. 9 shows a flow chart depicting an embodiment of PSM burst management, in which changes in segmentation control burst behavior.

FIG. 10 shows a flow chart depicting a second embodiment, in which changes in segmentation and duty cycle control burst behavior.

FIG. 11 shows simulated output voltage of a 70 MHz converter in pulse-skipping mode, according to the described embodiments, using changes in the number of active SW1 and SW2 segments to control burst behavior.

FIG. 12 shows the measured relative output voltage for a 70-MHz converter, with and without the described embodiments.

FIG. 13 shows analytic estimates of the output spectrum of a 70-MHz switched-mode converter with and without the described embodiments.

FIG. 14 shows measured output spectra of a radio-frequency power amplifier, using a 70-MHz switched-mode converter as a voltage source, with and without the described embodiments.

### DETAILED DESCRIPTION

The described embodiments include partitioning of one or more switch elements of a voltage regulator. The partitions of the switch elements are selectively activated to reduce harmonic content due to output equivalent series resistance ESR.

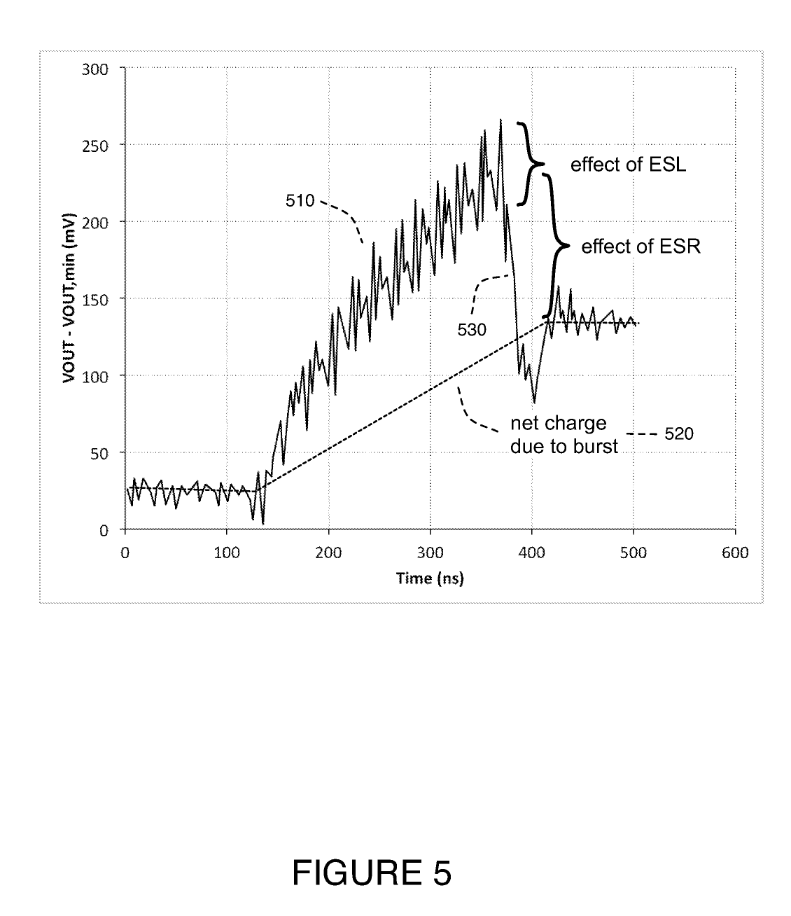

An example of a measured burst output voltage is depicted in FIG. 5, for a converter with a switching frequency of about 48 MHz. The individual switching transitions, somewhat distorted by the effects of other filtering components, can be seen in the fluctuations of the output voltage 510 with period around 21 nsec, due to the finite ESL of the filtering components. Furthermore, the output voltage rises above the value corresponding to the charge delivered to the output capacitor, shown as the dotted line 520, due to the charging current flowing through the capacitor ESR. At the end of the burst, the switches turn off, and the charging current rapidly falls to zero, causing an abrupt change 530 in the output voltage.

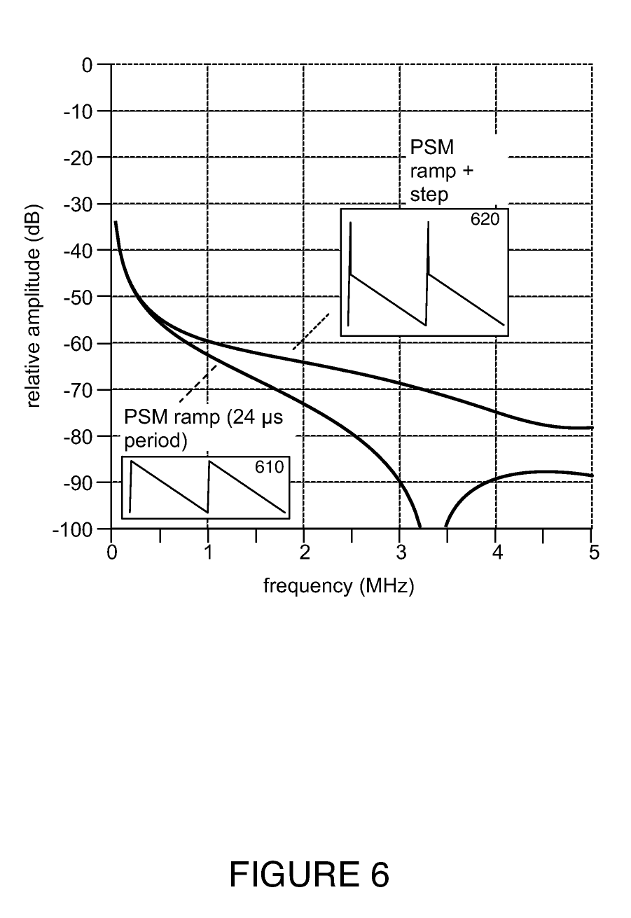

The resulting abrupt step produces an increase in broadband noise in the converter output. Analytic estimates of the power spectrum for an idealized PSM triangle wave, shown in inset 610, and a triangle wave with an abrupt step, shown in inset 620, are depicted in FIG. 6. The addition of the ESR ramp produces a substantial increase in harmonic content at high frequencies relative to the PSM period. The described embodiments provide suppression of the abrupt step in output voltage observed in FIG. 5, thereby reducing or eliminating broadband noise like that depicted in FIG. 6.

In an embodiment, at least the series switch SW1 is partitioned into a plurality of segments, each of which may participate in switching (active) or remain in an inactive condition in which that segment remains open when other segments alternate between open and closed (idle); the shunt switch SW2 may also be partitioned in a similar fashion.

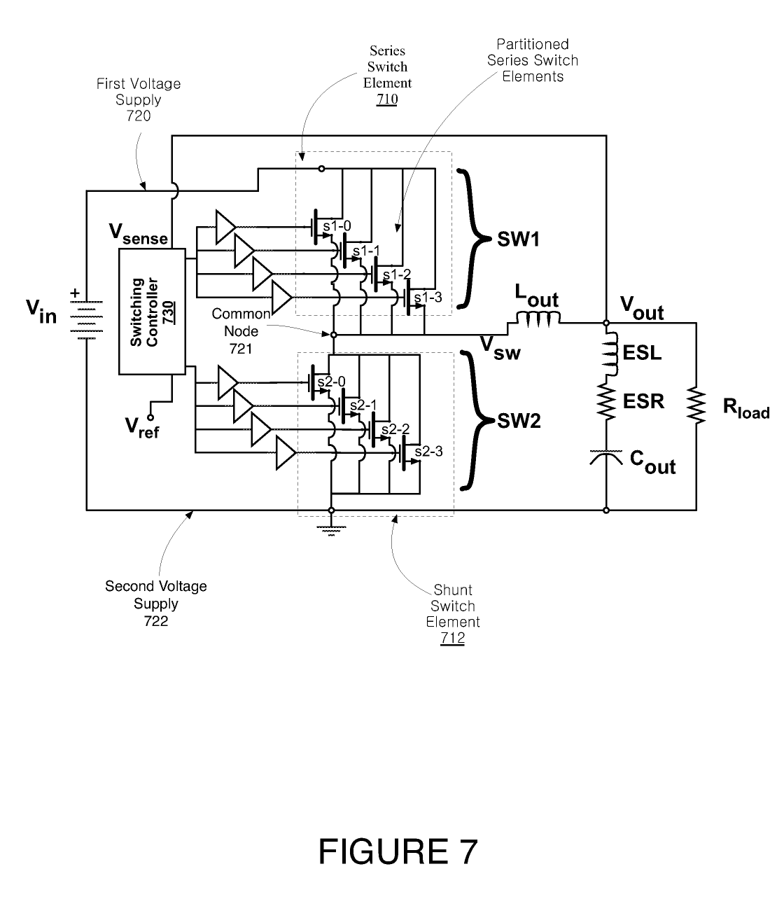

FIG. 7 shows a buck converter that includes a series switch element 710 and a shunt switch element 712, wherein the series switch element 710 includes a plurality of partitioned series switch elements s1-0, s1-1, s1-2, s1-3, according to an embodiment. As shown, the series switch element 710 is connected between a first voltage supply 720 and a common node 721. The shunt switch element 712 is connected between a second voltage supply 722 and the common node 721. A switching controller 730 controls closing and opening of the series switch element 710 and the shunt switch element 712, generating a switching voltage V_{SW} at the common node 721.

A partitioned switch of this type is described in U.S. Pat. No. 8,233,250, and a simplified example is depicted schematically in FIG. 7. In FIG. 7, s1-0 through s1-4 denote four independently-addressable segments of SW1, and s2-0 through s2-4 denote four independently-addressable segments of SW2. FIG. 7 shows NMOS devices being used in SW1, but PMOS devices can also be used. Each segment is driven independently, with control circuitry (not shown) to hold the associated driver circuitry idle when a specific segment is not active. In FIG. 7, four segments are depicted, but more or fewer segments may be employed, and the number of segments could differ for SW1 and SW2. In the case where SW1 is implemented using PMOS transistors, and SW2 is implemented using NMOS transistors, it may be advantageous to use differing numbers of active segments for SW1 and SW2.

For at least some embodiments, the switching controller 730 is operative to control the series switch element 710 and the shunt switch element 712 in an idle state, wherein none of the plurality of partitioned series switch elements s1-0, s1-1, s1-2, s1-3 are active. Further, the switching controller 730 is operative to control the series switch element 710 and the shunt switch element 712 in a burst state, wherein N of the plurality of partitioned series switch elements s1-0, s1-1, s1-2, s1-3 are active. Further, the switching controller 730 is operative to control the series switch element and the shunt switch element in a transition state, wherein M of the plurality of partitioned series switch elements are active, and wherein M is less than N. For the described embodiments, the active partitioned series switch elements are controllable for closing and opening of the series switch element. An output voltage (V_{OUT}) is generated at a load (R_{load}) of the voltage regulator.

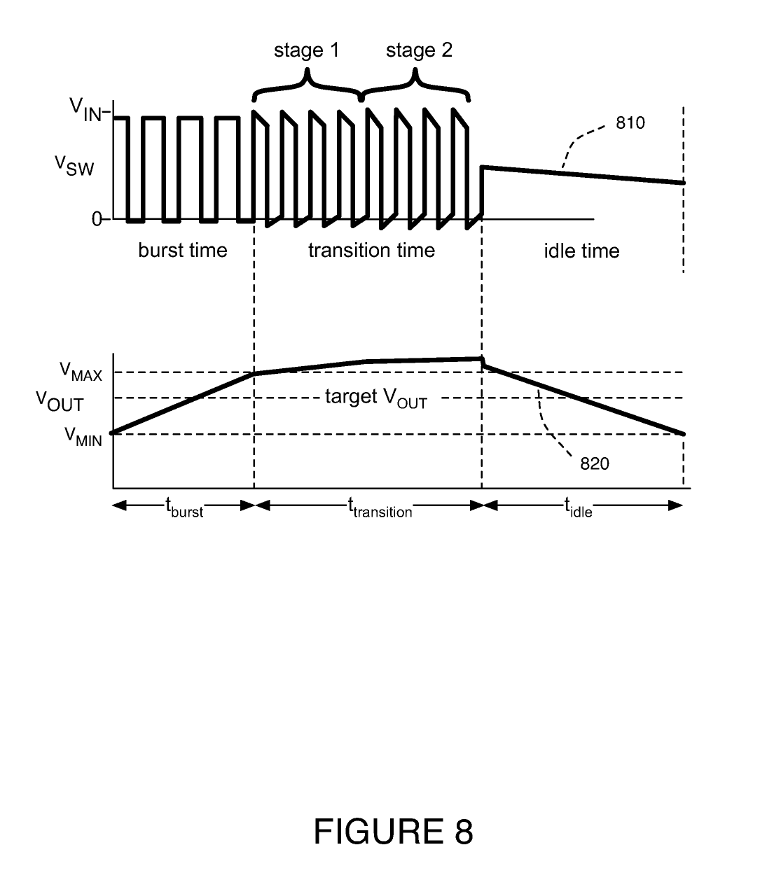

FIG. 8 shows in simplified form the time-dependent variation of the switch node voltage (trace 810) during PSM operation for the burst mode, the transition mode and the idle mode, according to an embodiment. Additionally, FIG. 8 shows the resulting averaged output voltage (trace 820) for the burst mode, the transition mode and the idle mode, according to an embodiment. As shown, the switching voltage V_{SW} as controlled by the switching controller 730 switches during the burst state and the transition state, but not during the idle state. Further, the switching controller 730 selects a different number partitioned series switch elements s1-0, s1-1, s1-2, s1-3 to be active during the transition state than the burst state. For example, the switching controller 730 may select all of the partitioned series switch elements s1-0, s1-1, s1-2, s1-3 to be active during the burst state, but may only select two of the partitioned series switch elements s1-0, s1-1, s1-2, s1-3 to be active during the transition state.

For at least some embodiments, the switching controller 730 is operative to transition the voltage regulator from the idle state to the burst state when the output voltage (V_{OUT}) is less than a V_{MIN} threshold. For at least some embodiments, the switching controller 730 is operative to transition from the burst state to the transition state when the output voltage (V_{OUT}) is greater than a V_{MAX} threshold. For at least some embodiments, the switching controller 730 is operative to transition from the transition state to the idle state after a predetermined number of switching cycles. For at least some embodiments, the switching controller 730 is operative to transition from the transition state to the idle state after a predetermined amount of time.

For at least some embodiments, the transition state includes a plurality of stages (wherein a stage is a portion of time of the transition state), wherein each stages includes the selection of a different number of partitioned series switch elements that are active. For an embodiment, the different number of partitioned series switch elements that are active decreases in time between the burst state and the idle state.

For at least some embodiments, a duty cycle of the closing and opening of the series switch element and the shunt switch element (basically, the switching voltage V_{SW}) decreases during the transition state. Further, for at least some embodiments, the duty cycle of the closing and opening of the series switch element and the shunt switch element decreases for each of the plurality of stages of the transition state.

For at least some embodiments, the shunt switch element includes a plurality of partitioned shunt switch elements, wherein none of the plurality of partitioned shunt switch elements are active during the idle state, and wherein L of the plurality of partitioned shunt switch elements are active during the burst state, and wherein K of the plurality of partitioned series switch elements are active during the transition state, and wherein K is less than L. That is, the number of active partitioned shunt switch elements is less during the transition state than during the burst state.

When a large number of segments is active, substantial driver power is used changing the switch state, but series parasitic resistance R_{par,sw} in the ON state is minimized. As the number of active segments is reduced, the series resistance of the overall switch increases. When the switches are operated at a duty cycle higher than that corresponding to the current output voltage, the average output current rises over times of order (Lₒᵤₜ/Rₚₐᵣ) to approximately

$${I}_{D C} = \frac{{DV}_{i n} - {V}_{out}}{{R}_{par}} ;$$

$${R}_{par} = {R}_{par , sw} + {R}_{par , ind}$$

where the total parasitic resistance Rₚₐᵣ is the sum of that due to the switch segments R_{par,sw} and the equivalent series resistance of the inductor R_{par,ind}. (The capacitor ESR is also present, but is usually small compared to R_{par,ind}.) It is expected that the resistance of n substantially identical segments in parallel will be reduced by roughly 1/n compared to the resistance of a single segment. The number of segments made active at a given time can be used to adjust the parasitic resistance of the overall switch; when a small number of segments are in use, the resistance is increased, and the peak charging current reduced. Thus, charging current, and consequently the effect of capacitor ESR on output voltage, can be reduced by decreasing the number of active segments.

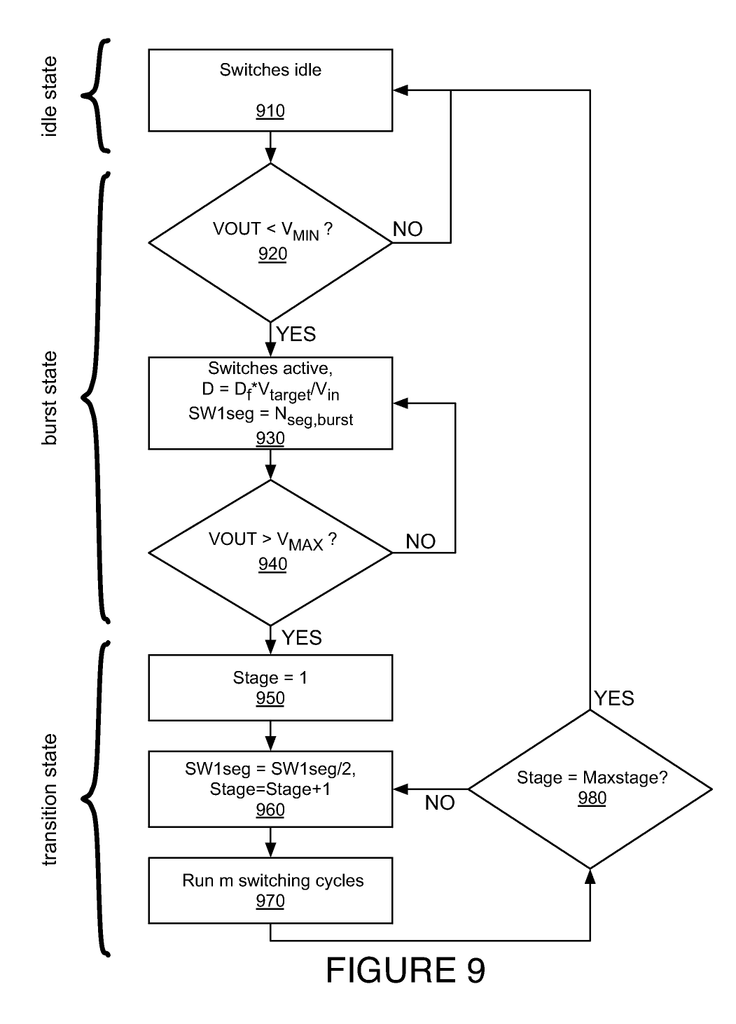

An exemplary embodiment is summarized in FIG. 9. The converter is presumed to have already entered PSM operation at the start of the cycle (step 910). The switches are held idle, saving power otherwise used to change the switch state. In this idle condition, both switches are open, and the input and output nodes are isolated. (Various other provisions to reduce power consumption may also be taken, depending on the architecture of the converter and the requirements of the application.) The output voltage is presumed to slowly fall, as the load current discharges the output capacitance, until the output voltage reaches the lower hysteresis threshold. This process typically requires a long time relative to the switching time T_{SW}. The output voltage is monitored, e.g. by a hysteretic comparator or other conventional means, and compared to the target output voltage requested from the converter through either a digital or analog input (step 920).

When the output voltage of the converter falls below the hysteresis threshold, the switches must become active again to recharge the output capacitance (step 930). The converter must operate at a duty cycle sufficiently high to charge the output capacitance, but not so high as to produce excessive inductor current. An exemplary method for achieving this end multiplies the ratio of target output voltage to input voltage by a D-factor D_{f}>1, to produce a duty cycle D corresponding to an increased nominal output voltage. The value of D_{f} is adjusted for a given converter and application. Various alternative means, such as the addition of a fixed voltage to the reference input, may also be employed. A fixed number of segments of SW1, N_{seg,burst}, is active during steps 930 and 940. The value of N_{seg,burst} is selected to optimize efficiency and charging time. SW2 may also be segmented, and a subset or all of the available segments employed, during step 930, as needed to optimize efficiency.

During the active period, the output voltage is compared against the upper hysteresis threshold (V_{MAX}) (step 940). When the output voltage reaches the upper hysteresis threshold, the first stage of the burst transition is initiated. The Stage parameter is set to 1 (step 950), and the number of active segments is reduced (step 960). In the exemplary embodiment, the number of segments is reduced by a factor of 2 for each new stage, but other approaches, such as a linear decrease in the number of active segments in each stage, may also be used. The switches continue in the active state for a fixed integer number of switching cycles, here denoted m (step 970). Note that the value of m may depend on the parameter Stage. A fixed time may also be used. If Stage is not yet equal to the maximum desired value Maxphase (step 980), the number of active segments is again reduced and another m switching cycles, or equivalent, are performed. If Stage=Maxphase, the switches are returned to the idle state (step 910), and the output voltage is allowed to discharge again until the lower hysteresis threshold (V_{MIN}) is reached, or PSM operation terminates.

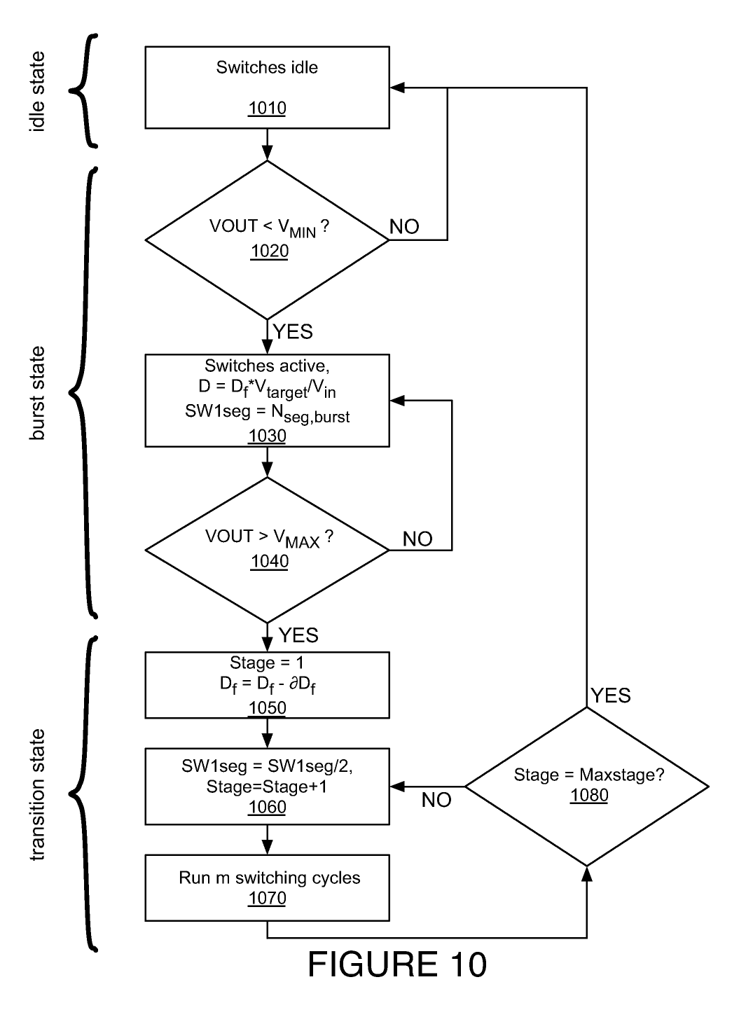

In an alternative embodiment, segment reduction may be combined with changes in duty cycle, through modification of the duty factor D_{f}. An example embodiment is depicted in FIG. 10. The duty factor is decreased by a predetermined amount ∂D_{f} upon entry into Stage 1 (step 1050). In an embodiment, the duty factor may be reduced by a fixed or variable increment for each successive stage.

It may also be desirable to change the response time of the means used to control duty cycle during the transition state procedure (steps 1050-1080) to allow the actual duty cycle of SW1 and SW2 to rapidly adjust to the requested value in each stage. In the embodiment of FIG. 10, the duty factor is reduced once at the beginning of the transition state procedure (steps 1050-1080), but in an alternative embodiment, the duty factor is reduced in stages each time the Stage parameter is incremented. Steps 1010-1040 are similar to steps 910-940.

Although the described embodiments employ activation of segments of a switch partitioned therein, other means of adjusting switch parasitic on-resistance may also be employed. For example, when an MOS transistor is used as the switch, the resistance of the transistor can be adjusted by changing the gate voltage applied during the transistor is turned on. For an n-channel (NMOS) device with small drain voltage,

$${R}_{on} \approx {μ}_{eff} {C}_{ox} [ \frac{W}{L} ] [ ( {V}_{g} - {V}_{th} ) - \frac{{V}_{D}}{2} ]$$

where Rₒₙ=R_{par,sw} is the low-field resistance, μ_{eff} is the effective carrier mobility, W the device width, L the gate length, V_{g} the gate voltage, Vₜₕ the threshold voltage, and V_{D} the drain voltage. Analogous considerations apply for PMOS transistors, or MESFET devices. By changing the gate voltage instead of, or in addition to, the number of active segments, during each stage of operation as described in FIG. 9 or FIG. 10, the desired objective of a gradual reduction in the charging current and ESR voltage may be achieved.

### EXAMPLE 1

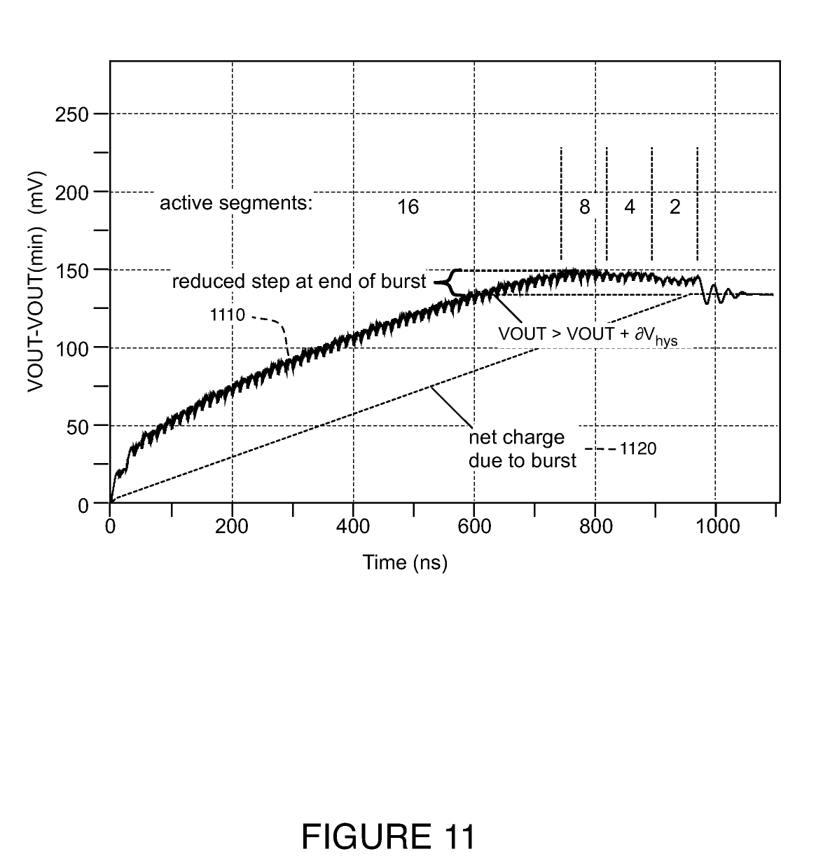

A simulated example of the results of the described embodiments is depicted in FIG. 11, for a converter with a switching frequency of about 70 MHz, in which SW1 and SW2 are both configured with 16 segments. The output voltage 1110 is seen to rise during the PSM burst, from 0 to about 750 nsec. When the desired hysteresis level is reached, the number of active segments of SW1 is reduced by factors of 2, from 16 to 8, 4, and 2 segments, after which switching is terminated, according to the method described in FIG. 9. In this case, the number of segments of SW2 is also scaled, but is kept two times larger than the number of segments used in SW1 when possible. The choice of segmentation for each stage depends on the tradeoff between resistance and driver power, and is specific to a given chip and application. It is apparent that, as a result, the output voltage transitions gradually to the target value, trace 1120, at the high hysteresis limit, rather than suddenly falling as was observed in FIG. 5.

### EXAMPLE 2

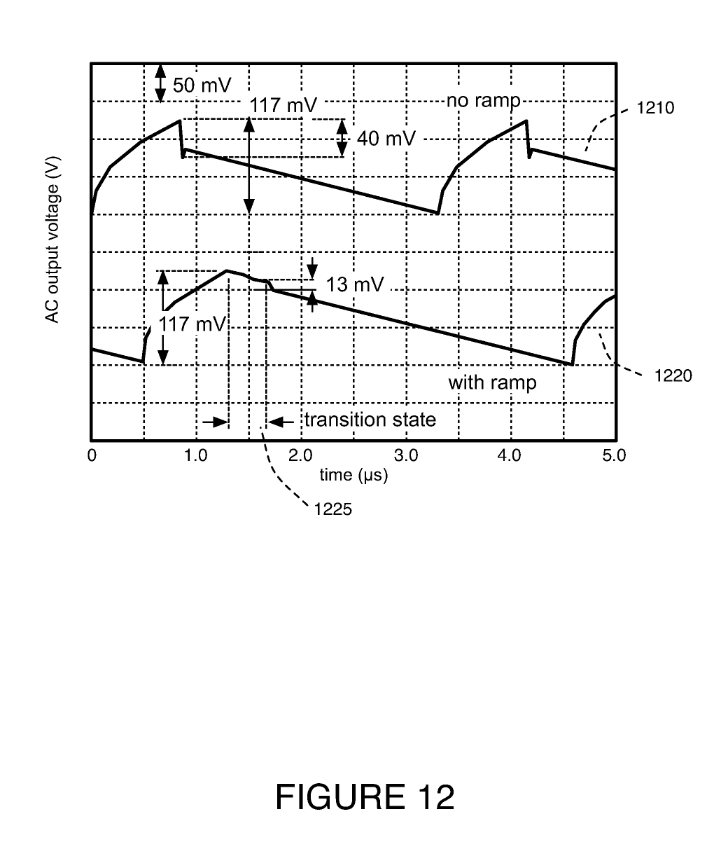

FIG. 12 shows the measured output voltage of a 70-MHz buck converter, in which SW1 and SW2 are both configured with 16 segments, with and without the use of the described embodiments. Note that the voltages here are displayed on a larger timescale than that used in FIG. 5 or 11 and have been subjected to a low-pass display filter, so that fluctuations due to individual switching events are not visible. The output voltage traces 1210 and 1220 are offset from one another for clarity; in both cases the DC average voltage is about 1.1 V. Trace 1210 (labeled “no ramp”) depicts the output voltage in the default configuration, in which all 16 segments are on during the PSM burst, and abruptly switched off when the instantaneous output voltage reaches the nominal target. It is apparent that the output voltage drops abruptly by about 40 mV at the termination of switching, similar to the behavior observed in FIG. 5. Trace 1220 (labeled with “ramp”) shows the output voltage of the same converter that includes the described embodiments according to FIG. 10 in use, under otherwise similar operating conditions. Using the terminology of FIG. 10 steps 1050 through 1080, Stages 1, 2, and 3 are used during transition state 1225; that is, Maxstage=3. The D-factor value employed during burst state (steps 1030 and 1040) is 1.1; this value is reduced to 1.0 in stage 1 (step 1050), and remains at that value through phases 2 and 3. In burst state operation (steps 1030 and 1040) all 16 segments of both switches are active. In stage 1 of the transition state, which lasts for 20 switching cycles (about 300 ns), 8 SW1 segments are active. In stage 2, 4 SW1 segments and 8 SW2 segments are active; in stage 3, 2 SW1 segments and 4 SW2 segments are active. Stages 2 and 3 last for 5 switching cycles or about 75 nsec each. The response time of the replica duty cycle control circuit is also decreased from about 300 ns in normal operation to 200 nsec during the transition state (stages 1-3).

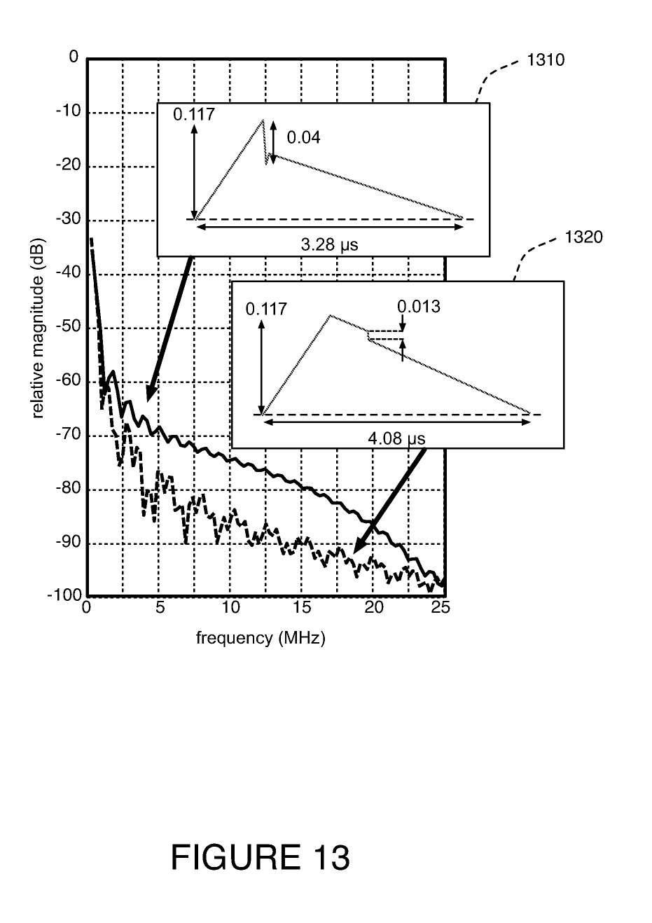

It is apparent from trace 1220 that the large step at the end of charging has been eliminated, and a small step of about 13 mV remains when stage 3 end (step 1080). FIG. 13 depicts an analytic estimate of the resulting output spectrum of the converter, based on the simplified triangle waveforms shown in insets 1310 (corresponding to default PSM operation as shown in trace 1210) and 1320 (with the use of the described embodiments, as shown by trace 1220). It is apparent that the described embodiments should provide on the order of 10-15 dB improvements in output noise in the frequency range of 5 to 20 MHz.

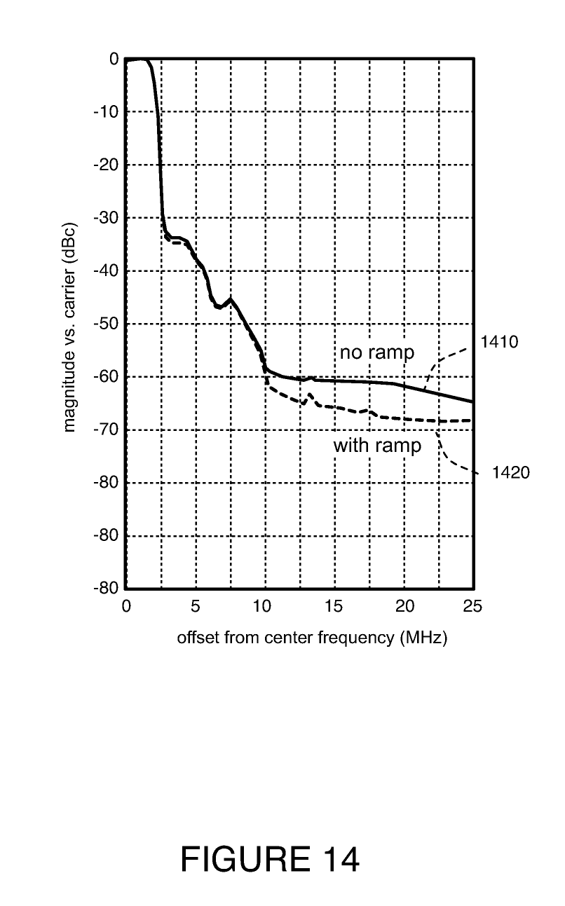

The measured output spectra of a power amplifier, carrying a modulated wideband CDMA (WCDMA) signal, driven by the converter of FIG. 12 are shown in FIG. 14. Trace 1410 corresponds to trace 1210, using the default PSM operating mode. Trace 1420 corresponds to trace 1220, using the described embodiments. The output spectrum of the amplifier within about 10 MHz of the carrier is dominated by nonlinear distortion of the intended signal, and is unaffected by the change in PSM operation. For frequency offsets greater than 10 MHz, the power amplifier distortion products become smaller, and the effect of improvements in PSM operation become apparent. The method of the described embodiments 1420 is seen to provide about a 6 dB improvement relative to conventional operation 1410, between 10 and 25 MHz from the carrier. It should be noted that the obtained improvements may be limited by remaining power amplifier distortion products, broadband amplifier noise, and instrument noise.

Although specific embodiments have been described and illustrated, the embodiments are not to be limited to the specific forms or arrangements of parts so described and illustrated.

What is claimed:

1. A voltage regulator, comprising:
a series switch element connected between a first voltage supply and a common node, wherein the series switch element comprises a plurality of partitioned series switch elements;
a shunt switch element connected between a second voltage supply and the common node;
a switching controller that controls closing and opening of the series switch element and the shunt switch element, generating a switching voltage at the common node, and is operative to:
control the series switch element and the shunt switch element in an idle state, wherein none of the plurality of partitioned series switch elements are active;
control the series switch element and the shunt switch element in a burst state, wherein N of the plurality of partitioned series switch elements are active; and
control the series switch element and the shunt switch element in a transition state, wherein M of the plurality of partitioned series switch elements are active, and wherein M is less than N.

2. The voltage regulator of claim 1, wherein only active partitioned series switch elements are controllable for closing and opening of the series switch element.

3. The voltage regulator of claim 1, wherein an output voltage is generated at a load of the voltage regulator.

4. The voltage regulator of claim 3, wherein the switching controller is operative to transition from the idle state to the burst state when the output voltage is less than a V_{MIN} threshold.

5. The voltage regulator of claim 3, wherein the switching controller is operative to transition from the burst state to the transition state when the output voltage is greater than a V_{MAX} threshold.

6. The voltage regulator of claim 3, wherein the switching controller is operative to transition from the transition state to the idle state after a predetermined number of switching cycles.

7. The voltage regulator of claim 3, wherein the switching controller is operative to transition from the transition state to the idle state after a predetermined amount of time.

8. The voltage regulator of claim 1, wherein the transition state includes a plurality of stages, wherein each stages includes selection of a different number of partitioned series switch elements that are active, and wherein the different number decreases in time between the burst state and the idle state.

9. The voltage regulator of claim 1, wherein a duty cycle of the closing and opening of the series switch element and the shunt switch element decreases during the transition state.

10. The voltage regulator of claim 9, wherein a duty cycle of the closing and opening of the series switch element and the shunt switch element decreases for each of the plurality of stages of the transition state.

11. The voltage regulator of claim 1, wherein the shunt switch element comprises a plurality of partitioned shunt switch elements, wherein none of the plurality of partitioned shunt switch elements are active during the idle state, and wherein L of the plurality of partitioned shunt switch elements are active during the burst state, and wherein K of the plurality of partitioned series switch elements are active during the transition state, and wherein K is less than L.

12. A voltage regulator, comprising:
a series switch element connected between a first voltage supply and a common node, wherein the series switch element comprises a plurality of partitioned series switch elements;
a shunt switch element connected between a second voltage supply and the common node;
a switching controller that controls closing and opening of the series switch element and the shunt switch element, generating a switching voltage at the common node, and is operative to:
control the series switch element and the shunt switch element in an idle state, wherein none of the plurality of partitioned series switch elements are active, and wherein a series resistance of series switch element is a value R_{off};
control the series switch element and the shunt switch element in a burst state, wherein a series resistance of the series switch element is a value Rₒₙ; and
control the series switch element and the shunt switch element in a transition state, wherein a series resistance of the series switch element is a value Rₒₙ₁, wherein Rₒₙ₁ is greater than Rₒₙ, and Rₒₙ₁ is less than R_{off}.

13. A voltage regulator, comprising:
a series switch element connected between a first voltage supply and a common node;
a shunt switch element connected between a second voltage supply and the common node, wherein the shunt switch element comprises a plurality of partitioned shunt switch elements;
a switching controller that controls closing and opening of the series switch element and the shunt switch element, generating a switching voltage at the common node, and is operative to:
control the series switch element and the shunt switch element in an idle state, wherein none of the plurality of partitioned shunt switch elements are active;
control the series switch element and the shunt switch element in a burst state, wherein L of the plurality of partitioned shunt switch elements are active; and
control the series switch element and the shunt switch element in a transition state, wherein K of the plurality of partitioned shunt switch elements are active, and wherein K is less than L.

14. A method of generating a regulated voltage, comprising:
generating the regulated voltage through controlled closing and opening of a series switch element and a shunt switch element, the series switch element being connected between a first voltage supply and a common node, and the shunt switch being connected between the common node and a second supply voltage, wherein the series switch element comprises a plurality of partitioned series switch elements; wherein the controlled closing and opening of a series switch element and a shunt switch element comprises:
an idle state, wherein none of the plurality of partitioned series switch elements are active;
a burst state, wherein N of the plurality of partitioned series switch elements are active; and
a transition state, wherein M of the plurality of partitioned series switch elements are active, and wherein M is less than N.

15. The method of claim 14, wherein only active partitioned series switch elements are controllable for closing and opening of the series switch element.

16. The method of claim 14, wherein an output voltage is generated at a load of the voltage regulator.

17. The method of claim 16, comprising transitioning from the idle state to the burst state when the output voltage is less than a V_{MIN} threshold.

18. The method of claim 16, comprising transitioning from the burst state to the transition state when the output voltage is greater than a V_{MAX} threshold.

19. The method of claim 16, comprising transitioning from the transition state to the idle state after a predetermined number of switching cycles.

20. The method of claim 16, comprising transitioning from the transition state to the idle state after a predetermined amount of time.

21. The method of claim 14, wherein the transition state includes a plurality of stages, wherein each stages includes selection of a different number of partitioned series switch elements that are active, and wherein the different number decreases in time between the burst state and the idle state.

22. The method of claim 14, wherein a duty cycle of the closing and opening of the series switch element and the shunt switch element decreases during the transition state.

23. The method of claim 14, wherein a duty cycle of the closing and opening of the series switch element and the shunt switch element decreases for each of the plurality of stages of the transition state.

24. The method of claim 14, wherein the shunt switch element comprises a plurality of partitioned shunt switch elements, wherein none of the plurality of partitioned shunt switch elements are active during the idle state, and wherein L of the plurality of partitioned shunt switch elements are active during the burst state, and wherein K of the plurality of partitioned series switch elements are active during the transition state, and wherein K is less than L.
